(19) United States
(12) Patent Application Publication
(10) Pub. No.: US 2025/0223820 A1
(43) Pub. Date: Jul. 10, 2025

(54) GRATING FOR FALL PREVENTION AND CABLE DUCT MOUNTED ON GRATING

(71) Applicant: SGU Tech Co.,LTD, Hwasung-si (KR)

(72) Inventor: Sang-Kon You, Hwasung-si (KR)

(21) Appl. No.: 18/407,394

(22) Filed: Jan. 8, 2024

(51) Int. Cl. E04G 21/32; H02G 1/08

(52) U.S. Cl. CPC E04G 21/3252; H02G 1/08

(57) ABSTRACT

Provided is a grating for fall prevention and a cable duct mounted on the grating, which includes: a cover; a plate which forms the floor surface of the FAB where the production equipment is located, and includes a rectangular opening provided in the center and a seating part provided around the opening where the cover is placed; and a housing which is provided below the plate, accommodates the cables of the production equipment that come down through adjacent gratings forming the floor surface of the FAB, and sends the cables down to the clean sub FAB (CSF) through the cable duct mounted in the second opening on the floor.

### BACKGROUND OF THE PRESENT DISCLOSURE

### Field of the Present Disclosure

The present disclosure relates to a grating and a cable duct mounted on the grating, and more specifically, to a grating for fall prevention and a cable duct mounted on the grating, which enable safe working by eliminating the risk of falls during cable laying work below the access floor of a semiconductor fabrication facility (FAB).

### Background Art

In general, a building where semiconductors are manufactured is called a line, and the structure of the line mainly consists of a two-floor structure of FAB (Clean Room)+Sub FAB (Plenum) or a three-floor structure of FAB+clean sub FAB (CSF)+facility sub FAB (FSF). Here, the FAB is a clean room where semiconductor processes are conducted, most workers perform their tasks, and the operation and maintenance of production equipment are achieved.

The Sub FAB is a space where auxiliary facilities which provide gases and chemicals needed for the process to the production equipment and remove (exhaust) residual chemicals after the process are located, and can be divided into a CSF (1st Plenum) and an FSF (2nd Plenum). A wafer manufacturing line of 200 mm or under has a FAB+Sub FAB structure, but recently, as the wafer size has increased to 300 mm to enhance production efficiency and equipment density has also increased, a FAB+CSF+FSF structure which is formed by division of the sub FAB into two layers has been adopted.

FIG. 1(A) illustrates the structure of FAB+CSF+FSF. The height (floor-to-floor) among the FAB, the CSF, and the FSF is about 7 to 14M. During cable connection, depending on the locations of conventional cable trays, approximately five to six workers, including one person for the upper floor, two between floors, one for lower floor, and one safety officer for each floor, perform high-altitude work. Accordingly, the workers are exposed to risks.

FIG. 1(B) illustrates the view from above in the CSF. The cable tray is installed above the CSF, and the cable tray includes power cables, instrumentation cables, communication cables, etc. Generally, as cable trays are installed in high areas, most construction and maintenance work corresponds to high-altitude work. The greatest risk during cable tray work is falls. Since the cable tray work depends on safety gear and ladders, it leads to injury or death due to a momentary mistake while working.

In addition to falls, while workers step on various structures, such as lattice columns, primary trays, piping, etc., there may occur secondary accidents, such as utility damage, electrical accidents, malfunction of sprinklers, and the likes.

Therefore, cable tray structure needs to be improved to eliminate high-altitude work and prevent falls.

### PATENT LITERATURE

### Patent Documents

Patent Document 1: Korean Patent No. 10-1913500
Patent Document 2: Korean Utility Model Registration No. 20-0143673

### SUMMARY OF THE PRESENT DISCLOSURE

Accordingly, the present disclosure has been made to solve the above-mentioned problems occurring in the prior arts, and it is an objective of the present disclosure to provide a grating for fall prevention and a cable duct mounted on the grating, which can eliminate high-altitude work and prevent falls during cable work in a semiconductor fabrication facility (FAB), and allows quick progression of cable laying work by sending cables of production equipment down to a clean sub FAB (CSF) through the cable duct mounted on the grating.

To accomplish the above object, according to the present disclosure, there is provided a grating for fall prevention and a cable duct mounted on the grating, including: a cover; a plate which forms the floor surface of the FAB where the production equipment is located, and includes a rectangular opening provided in the center and a seating part provided around the opening where the cover is placed; and a housing which is provided below the plate, accommodates the cables of the production equipment that come down through adjacent gratings forming the floor surface of the FAB, and sends the cables down to the clean sub FAB (CSF) through the cable duct mounted in the second opening on the floor.

When the cover is seated on the seating part, the top surfaces of the cover and the plate form the same height.

The housing includes four side wall parts, and a bottom part, which finishes by covering lower portions of the side wall parts and has a second opening formed in the center in a circular shape to let the cable (C) down.

Specifically, the first opening is formed on at least one of the four side wall parts, and the cable of the production equipment used in the FAB is accommodated in the housing through the first opening, and then, is sent down to the CSF through the cable duct mounted in the second opening through an accommodation space inside the housing.

The cable duct is sent down to a height of 2 meters from the floor surface of the CSF.

The cable duct includes: a plurality of cylindrical bodies; and a connection rotation means which connects two neighboring cylindrical bodies (first cylindrical body, and second cylindrical body) to be rotatable in the connected state.

Specifically, the connection rotation means includes:
a first connection rotation part which includes: a first fixing pin fixed on one side of the end of the first cylindrical body; a second fixing pin fixed on one side of the end of the second cylindrical body; and a first connection part of which one end is rotatably coupled to the first fixing pin and the other end is rotatably coupled to the second fixing pin; and
a second connection rotation part which includes: a third fixing pin fixed on the other side of the end of the first cylindrical body; a fourth fixing pin fixed on the other side of the end of the second cylindrical body; and a second connection part of which one end is rotatably coupled to the third fixing pin and the other end is rotatably coupled to the fourth fixing pin, wherein the first connection rotation part and the second connection rotation part are rotated in the same direction.

Moreover, the uppermost cylindrical body among the cylindrical bodies includes:
a ring-shaped head part fixed to the top of the cylindrical body to be placed on the circumference of the second opening.

According to the present disclosure, since there is no need to install a tray above the CSF during the cable laying work in the fabrication facility (FAB), the grating and the cable duct mounted on the grating do not need high-altitude work, and can prevent injuries and deaths due to falls since there is no risk of falls even when the grating is open.

Moreover, the grating and the cable duct mounted on the grating allows workers to quickly work in safety without high-altitude work since, during cable laying work, the cable duct is inserted into the grating and is lowered to an area around a main power box (MPB) to finish the work.

Furthermore, the grating and the cable duct mounted on the grating can prevent damage of utility and prevent electrical accidents and malfunction of sprinklers since there is no need to step on and move across trays, cables, and piping.

As described above, the present disclosure provides a novel safety grating and cable duct that improve the structures of conventional semiconductor FAB grating and cable trays, thereby by eliminating the need for high-altitude work during cable laying work and preventing injuries and deaths caused by falls.

### BRIEF DESCRIPTION OF THE DRAWINGS

FIG. 1(A) is an illustrative diagram illustrating a structure of each floor of a conventional semiconductor FAB, and FIG. 1(B) is a view from above in a CSF.

FIG. 2 is a perspective view of a grating for fall prevention according to the present disclosure.

FIG. 3 is a side view of the grating for fall prevention according to the present disclosure.

FIG. 4 is a bottom perspective view of the grating for fall prevention according to the present disclosure.

FIG. 5 is a plan view illustrating a state in which a cover of the grating for fall prevention according to the present disclosure is opened.

FIG. 6 is an illustrative diagram illustrating a state in which the grating for fall prevention according to the present disclosure is installed in a semiconductor FAB.

FIG. 7 is an illustrative diagram illustrating a FAB floor and a CSF floor below the FAB floor on the site where the grating for fall prevention and a cable duct mounted on the grating are installed.

FIG. 8 is a perspective view showing a state in which the cable duct is being mounted on the grating for fall prevention according to the present disclosure.

FIG. 9 is a perspective view of the cable duct according to the present disclosure and an enlarged view of each part.

FIG. 10(A) is a cross-sectional view of the grating for fall prevention and the cable duct mounted on the grating, and FIG. 10(B) is a side view of the grating for fall prevention and the cable duct mounted on the grating.

FIG. 11 is a perspective view illustrating the state in which the cable duct is mounted on the grating for fall prevention according to the present disclosure.

### DETAILED DESCRIPTION OF THE PREFERRED EMBODIMENT

Advantages and features of the present disclosure and methods accomplishing the advantages and features will become apparent from the following detailed description of exemplary embodiments with reference to the accompanying drawings.

However, the present disclosure is not limited to exemplary embodiment disclosed herein but will be implemented in various forms.

The exemplary embodiments are provided so that the present disclosure is completely disclosed, and a person of ordinary skilled in the art can fully understand the scope of the present disclosure.

Additionally, the present disclosure will be defined only by the scope of the appended claims.

Therefore, in some embodiments, well-known components, operations, and techniques are not described in detail to avoid making the present disclosure ambiguous.

In this specification, the same reference numerals denote the same components, and the terms used (mentioned) in the specification are for explaining the embodiments and are not intended to limit the present disclosure.

In the specification, the terms of a singular form may include plural forms unless otherwise specified. It should be also understood that the terms of ‘include’ or ‘have’ in the specification are used to mean that there is no intent to exclude existence or addition of other components besides components described in the specification.

Unless otherwise defined, all terms (including technical and scientific terms) used herein have the same meaning as commonly understood by those skilled in the technical field to which the present disclosure pertains.

It will be further understood that terms, such as those defined in commonly used dictionaries, should not be interpreted in an idealized or overly formal sense unless expressly so defined herein.

Hereinafter, preferred embodiments of the present disclosure will be described in detail with reference to the accompanying drawings.

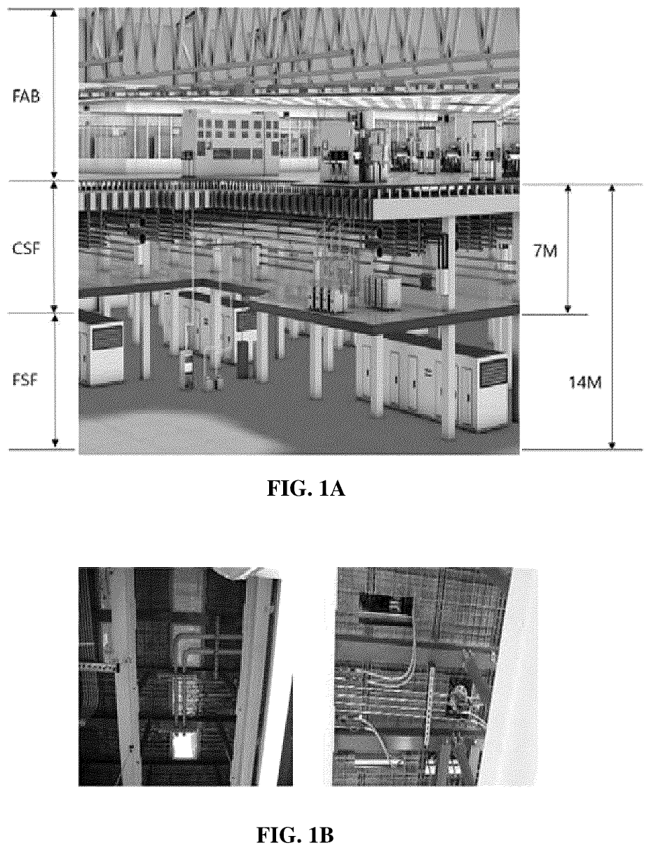

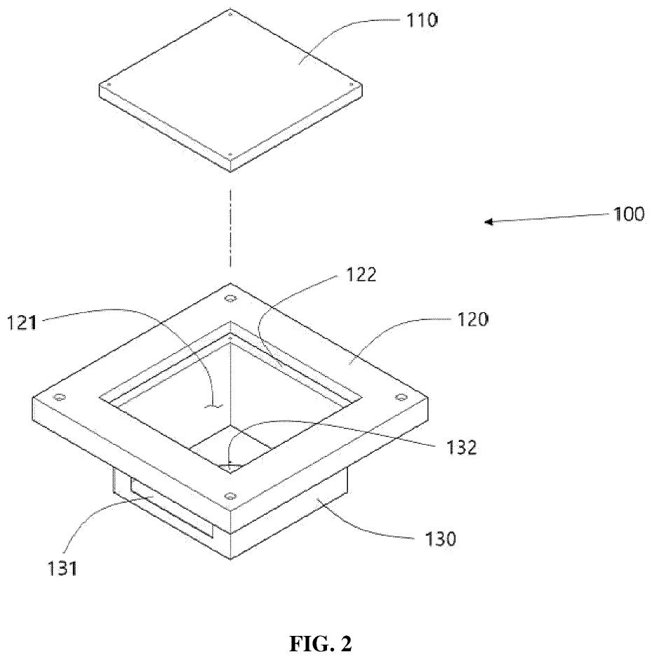

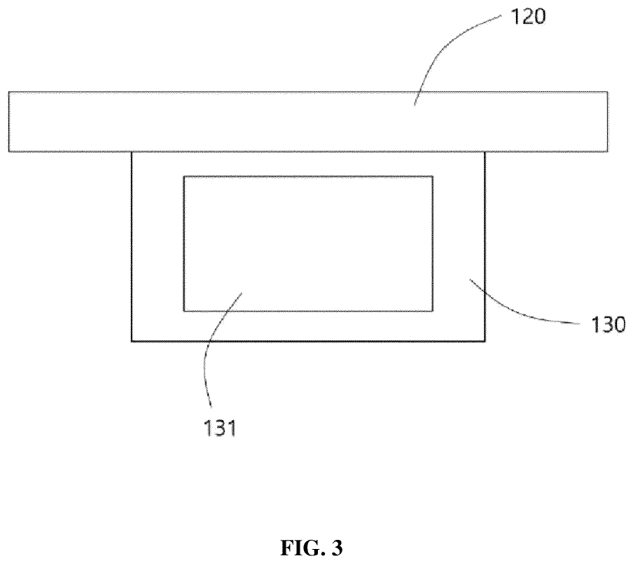

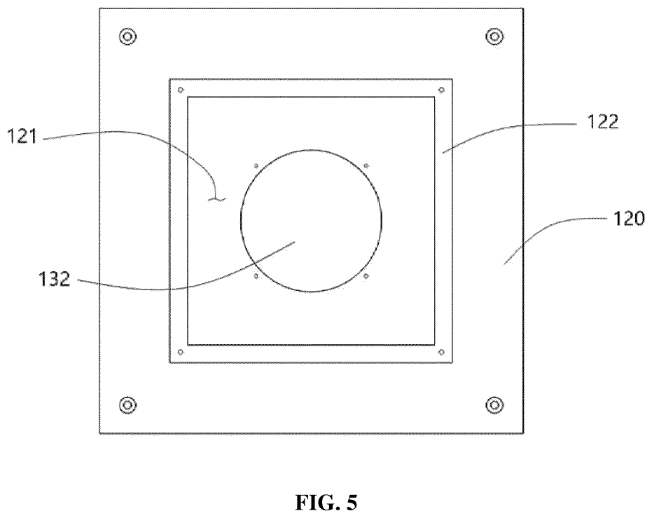

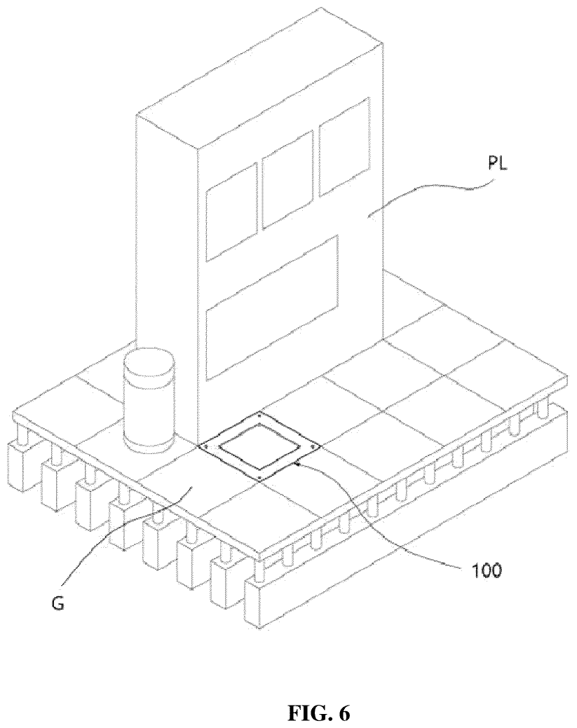

Referring to FIGS. 2 to 7, a grating 100 for fall prevention according to the present disclosure comprises a cover 110, a plate 120, and a housing 130. The grating 100 for fall prevention forms the floor surface of a fabrication facility (FAB) as illustrated in FIGS. 1(A) and 1(B). The grating 100 for fall prevention according to the present disclosure can be applied to a portion of the existing FAB floor surface which requires the application of the present disclosure.

The cover 110 is seated on the plate 120.

The plate 120 forms the floor surface of the FAB where the production equipment is located, and has a rectangular opening 121 in the center, and a seating part 122 where the cover 110 is seated is formed on the circumference of the opening 121. The seating part 122 is formed with a step down from the upper surface of the plate 120 towards the opening 121.

The housing 130 is provided in a rectangular box shape below the plate 120. A cable (C) of production equipment (PL), which is lowered through an adjacent grating (G) forming the floor surface of the FAB, is accommodated in the housing 130 through a first opening 131 of the side, and then, is sent down to a main power box (MPB) of a clean sub FAB (CSF) through a cable duct 200 mounted in a second opening 132 on the bottom.

When working in the FAB, a worker opens the cover 110 and puts the cable of the production equipment lowering down after passing through the adjacent grating (G) into the housing 130 through the first opening 131, and then, sends down the cable toward the MPB of the CSF through the cable duct 200 mounted in the second opening 132 of the floor, thus completing the cable laying work in the FAB. Even when the cover 110 is open, since the housing 130 is installed below the cover 110 and the cable duct 200 through which the cable (C) passes is installed in the center of the housing 130, the accident that the worker falls down while working with the cover 110 open can be fundamentally prevented.

The types of cables (C) of the production equipment (PL) include UPS power cables, TM.LL power-signal cables, power cables, ground cables, RF coaxial-SYNC-signal cables, and various other cables.

When the cover 110 is seated on the seating part 122, the top surfaces of the cover 110 and the plate 120 form the same height.

The housing 130 includes four side wall parts 130a, 130b, 130c, and 130d, and a bottom part 130e, which finishes by covering lower portions of the side wall parts 130a, 130b, 130c, and 130d and has the second opening 132 formed in the center in a circular shape to let the cable (C) down.

When the cover 110 is open for cable work, the bottom of the housing 130 is blocked by the bottom part 130e and the housing is opened to the size of the second opening 132 which is formed in the center to allow the cable (C) to pass through, thus preventing the worker from falling into the CSF.

The first opening 131 is formed on at least one of the four side wall parts 130a, 130b, 130c, and 130d, and the cable of the production equipment used in the FAB is accommodated in the housing through the first opening 131, and then, is sent down to the CSF through the cable duct 200 mounted in the second opening 132 through an accommodation space inside the housing 130.

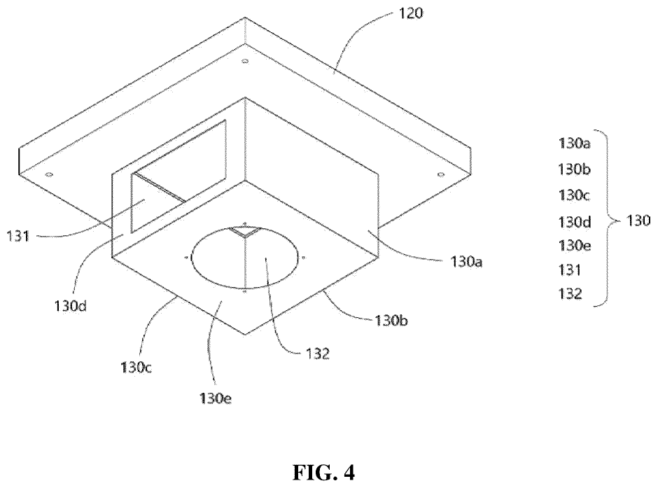

FIG. 4 illustrates an example where only one first opening 131 is formed on the side wall part 130d, but more first openings 131 can be formed in other side wall parts 130a, 130b, and 130c according to the position and situation of the FAB production equipment (PL), thereby allowing more cables (C) to be sent down through the cable duct 200.

Of course, considering the diameters of the second opening 132 and the cable duct 200, the number of the first openings 131 is properly one or two. In order to send down more cables to the CSF, it is preferable to additionally install gratings for fall prevention and cable ducts according to the present disclosure in adjacent locations of the relevant production equipment.

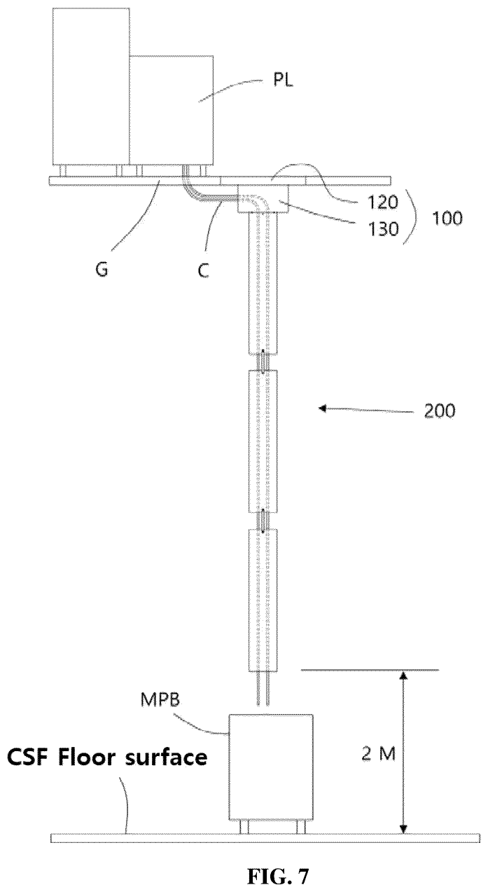

Referring to FIG. 7, the cable duct 200 is sent down to a height of 2 meters from the floor surface of the CSF, thereby allowing for easy connection of cables to the lower main power box (MPB).

The cable duct 200 mounted on the grating 100 will be described in detail.

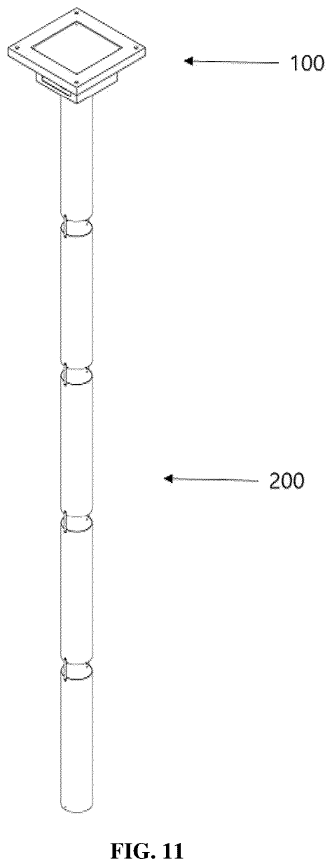

Referring to FIGS. 7 to 11, the cable duct 200 includes a plurality of cylindrical bodies 210 and connection rotation means 220.

The plurality of cylindrical bodies 210 are connected, and several cables (C) of the production equipment (PL) pass through the inside of the cylindrical bodies 210, and then, are sent down to the CSF.

The connection rotation means 220 connect two adjacent cylindrical bodies (first cylindrical body 210, second cylindrical body 210) in such a way that they are rotatable while being connected.

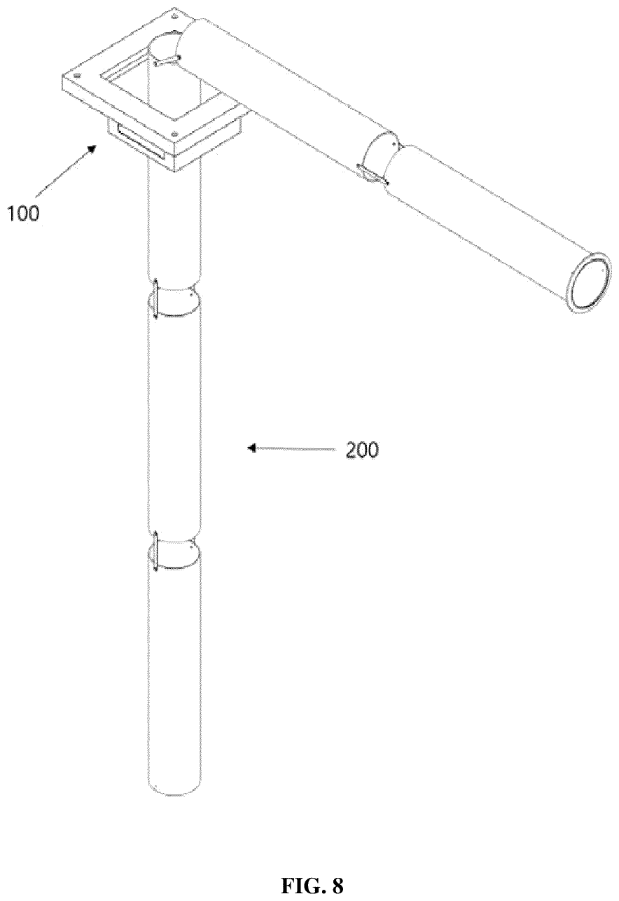

Referring to FIG. 8, since the cylindrical body 210 can be rotated by the connection rotation means 220 constituting the cable duct 200, the cable duct 200 can be easily mounted on the grating 100.

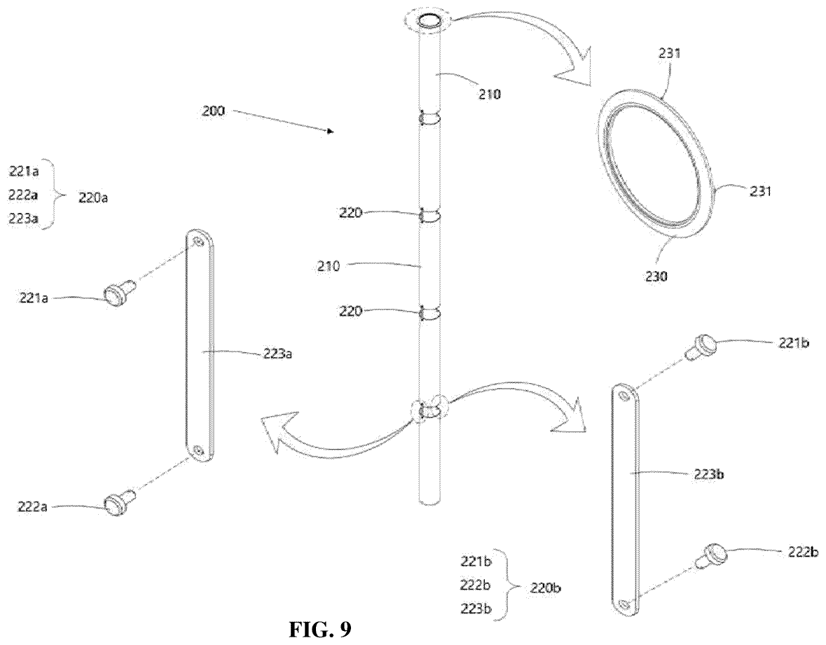

Referring to FIG. 9, the connection rotation means 220 includes a first connection rotation part 220a and a second connection rotation part 220b.

The first connection rotation part 220a includes: a first fixing pin 221a fixed on one side (left side) of the end of the first cylindrical body 210; a second fixing pin 222a fixed on one side (left side) of the end of the second cylindrical body 210; and a first connection part 223a of which one end is rotatably coupled to the first fixing pin 221a and the other end is rotatably coupled to the second fixing pin 222a.

The second connection rotation part 220b includes: a third fixing pin 221b fixed on the other side (right side) of the end of the first cylindrical body 210; a fourth fixing pin 222b fixed on the other side (right side) of the end of the second cylindrical body 210; and a second connection part 223b of which one end is rotatably coupled to the third fixing pin 221b and the other end is rotatably coupled to the fourth fixing pin 222b. Thus, the first connection rotation part 220a and the second connection rotation part 220b are rotated in the same direction.

In this instance, it is important that the first connection part 223a and the second connection part 223b are not too short in length to allow the first cylindrical body 210 and the second cylindrical body 210 adjoining each other to sufficiently bend up to about 90° during rotation.

Referring to FIGS. 8 to 11, the first connection rotation part 220a and the second connection rotation part 220b are installed at positions of both sides of the first cylindrical body 210 and the second cylindrical body 210, which do not hinder the rotation of the first cylindrical body 210 and the second cylindrical body 210. Accordingly, when the first cylindrical body 210 and the second cylindrical body 210 which are connected at a certain distance apart from each other are bent and rotated by using the first connection rotation part 220a and the second connection rotation part 220b, the first cylindrical body 210 and the second cylindrical body 210 can rotate up to a predetermined angle without touching each other.

FIG. 8 illustrates an example where the first cylindrical body 210 and the second cylindrical body 210 are bent and rotated up to about 90°.

As described above, since the cylindrical body 210 can be sufficiently bent and rotated, the plurality of cylindrical bodies 210 can easily and sequentially pass through the circular second opening 132 formed in the floor of the housing 130, thereby facilitating the insertion work of the cable duct 200.

The cylindrical body 210 located at the uppermost position includes a ring-shaped head part 230 which is fixed to the top of the cylindrical body 210 so as to be placed on the circumference of the second opening 132. The ring-shaped head part 230 has a plurality of protrusions 231 formed on the bottom surface thereof to be inserted and fixed to the cylindrical body 210.

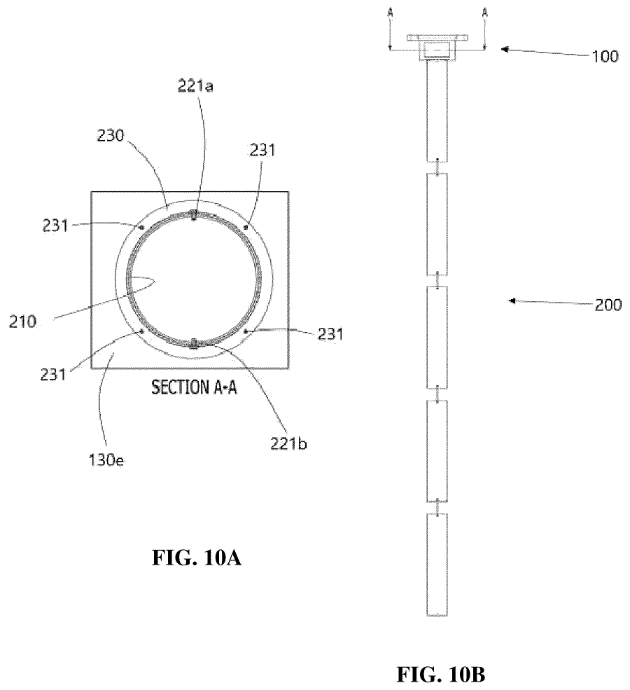

Referring to FIGS. 10(A) and 10(B), when the plurality of cylindrical bodies 210 are sequentially passed through the second opening 132, the ring-shaped head part 230 installed on top of the uppermost cylindrical body 210 is retained and installed on the bottom part 130e around the circumference of the second opening 132. Additionally, the cover 110 is closed on the plate 120 to finish.

The present disclosure relates to a novel grating and a cable duct mounted on the grating to eliminate high-altitude work and prevent falls and fatalities during cable laying work in a semiconductor FAB. That is, the present disclosure proposes a new structure of grating for fall prevention and a cable duct, which can allow for faster and safer work, not the conventional cable tray method for cable laying.

While the present disclosure has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present disclosure.

What is claimed is:

1. A grating for fall prevention and a cable duct mounted on the grating, during cable laying work below the access floor of a semiconductor fabrication facility (FAB), for preventing falls and high-altitude work of workers by sending cables of production equipment down to a clean sub FAB (CSF) through a cable duct mounted on the grating, comprising:
a cover;
a plate which forms the floor surface of the FAB where the production equipment is located, and includes a rectangular opening provided in the center and a seating part provided around the opening where the cover is placed; and
a housing which is provided below the plate, accommodates the cables of the production equipment that come down through adjacent gratings forming the floor surface of the FAB, and sends the cables down to the clean sub FAB (CSF) through the cable duct mounted in the second opening on the floor,
wherein the cable duct comprises:
a plurality of cylindrical bodies; and
a connection rotation means which connects two neighboring cylindrical bodies (first cylindrical body, and second cylindrical body) to be rotatable in the connected state,
wherein the connection rotation means comprises:
a first connection rotation part which includes: a first fixing pin fixed on one side of the end of the first cylindrical body; a second fixing pin fixed on one side of the end of the second cylindrical body; and a first connection part of which one end is rotatably coupled to the first fixing pin and the other end is rotatably coupled to the second fixing pin; and
a second connection rotation part which includes: a third fixing pin fixed on the other side of the end of the first cylindrical body; a fourth fixing pin fixed on the other side of the end of the second cylindrical body; and a second connection part of which one end is rotatably coupled to the third fixing pin and the other end is rotatably coupled to the fourth fixing pin,
wherein the first connection rotation part and the second connection rotation part are rotated in the same direction,
wherein the uppermost cylindrical body among the cylindrical bodies includes a ring-shaped head part fixed to the top of the cylindrical body to be placed on the circumference of the second opening,
wherein the ring-shaped head part includes a plurality of protrusions provided on the bottom surface thereof to be inserted and fixed to the cylindrical body,
wherein, when the plurality of cylindrical bodies are sequentially passed through the second opening, the ring-shaped head part installed on top of the uppermost cylindrical body is retained and installed on the bottom part around the circumference of the second opening, and
wherein the first connection rotation part and the second connection rotation part are installed at positions of both sides of the first cylindrical body and the second cylindrical body, which do not hinder the rotation of the first cylindrical body and the second cylindrical body such that, when the first cylindrical body and the second cylindrical body connected at a certain distance apart from each other are bent and rotated by using the first connection rotation part and the second connection rotation part, the first cylindrical body and the second cylindrical body can rotate up to a predetermined angle without touching each other.

2. The grating for fall prevention and a cable duct mounted on the grating according to claim 1, wherein when the cover is seated on the seating part, the top surfaces of the cover and the plate form the same height.

3. The grating for fall prevention and a cable duct mounted on the grating according to claim 1, wherein the housing includes four side wall parts, and a bottom part, which finishes by covering lower portions of the side wall parts and has a second opening formed in the center in a circular shape to let the cable (C) down.

4. The grating for fall prevention and a cable duct mounted on the grating according to claim 3, wherein the first opening is formed on at least one of the four side wall parts, and the cable of the production equipment used in the FAB is accommodated in the housing through the first opening, and then, is sent down to the CSF through the cable duct mounted in the second opening through an accommodation space inside the housing.

5. The grating for fall prevention and a cable duct mounted on the grating according to claim 1, wherein the cable duct is sent down to a height of 2 meters from the floor surface of the CSF.
